(19) United States
(12) Patent Application Publication
(10) Pub. No.: US 2026/0054454 A1
(43) Pub. Date: Feb. 26, 2026

(54) THERMOPLASTIC WELDING ACROSS SECONDARY FLANGES

(71) Applicant: Magna Exteriors Inc., Aurora (CA)

(72) Inventors: Christopher J. Kuntze, Goodrich, MI (US); Laurent Gillard, Beverly Hills, MI (US); Heiner Salzmann, Metamora, MI (US)

(73) Assignee: Magna Exteriors Inc., Aurora (CA)

(21) Appl. No.: 19/305,947

(22) Filed: Aug. 21, 2025

Related U.S. Application Data
(60) Provisional application No. 63/685,570, filed on Aug. 21, 2024.
(60) Provisional application No. 63/686,600, filed on Aug. 23, 2024.

(51) Int. Cl. B29C 65/02; B29C 65/00; B29L 31/30; B60Q 1/30

(52) U.S. Cl. CPC B29C 65/02; B29C 66/131; B29C 66/43; B29C 66/828; B60Q 1/30; B29L 2031/3005

(57) ABSTRACT

Incorporating thermoplastic welding across predetermined plurality of flanges, wherein the flanges are operably adapted to meet predetermined best practice weld angles and meet best practice panel loading angle(s). The added flanges may require special tool action such as lifters, and may not be molded with just the core and cavity of the mold. The flanges are suitably strong enough to support the pressures needed for welding, even through non-direct contact. There is operably provided part environments that allow for plastic welding in at least one predetermined area where needed, or at least one predetermined continuous weld as needed, and eliminates the difficult welding or non-weldable areas.

### CROSS-REFERENCE TO RELATED APPLICATIONS

This application is a Non-Provisional Patent Application and claims benefit of United States Provisional Ser. No. 63/686,600 , filed Aug. 23, 2024, and United States Provisional Ser. No. 63/685,570 , filed Aug. 21, 2024. The disclosures of the above applications are incorporated herein by reference.

### FIELD OF THE INVENTION

The present invention relates to incorporating thermoplastic welding across flanges and method for manufacturing same.

### BACKGROUND OF THE INVENTION

Welding surfaces on parts typically need nest support on the back side of a part to provide load and force to allow the welding surfaces to wet out to each other. Flanges for plastic welding on mating parts need to be open to each other with draft type angle(s) to allow loading, to avoid interference, and to avoid wiping of the welding surface(s). This helps assure a proper weld, or a continuous weld where needed or desired, for a water or airtight weld.

However, it is known that not all styled surfaces and flanges on components support plastic welding best practices, which is an issue.

Secondary components, such as brackets, adhesive, tapes, caulks, butyl, foam, seals, etc., could help eliminate the non-weld areas but secondary operations and components drive the component and/or manufacturing costs up, could drive the weight up, and could also drive the quality down and allow for poor quality builds or part durability concerns.

Therefore, it is desired to create part environments that allow for plastic welding in predetermined areas where needed, or a predetermined continuous weld as needed, and eliminate the difficult or non-weldable areas.

### SUMMARY OF THE INVENTION

The present invention generally provides thermoplastic welding across at least one flange, more preferably, thermoplastic welding across a plurality of secondary flanges.

In accordance with aspects of the present invention, to integrate predetermined secondary welding flanges that support a suitable plastic welding design and operation that supports a robust design, meets best practices, and keeps cost down and complexity minimized.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 depicts a cross-sectional view incorporating surfaces close to parallel to a load angle;

FIG. 2 is a cross-sectional view incorporating secondary modified flanges angled to improve loading and welding, in accordance with the present invention;

FIG. 3 is a cross-sectional view depicting exemplary modified flanges incorporating a gap, the modified flanges allow improved loading and good plastic welding conditions for creating desired welds, in accordance with aspects of the present invention;

FIG. 4 is a cross-sectional view depicting exemplary modified flanges to allow improve loading and good plastic welding conditions for creating desired welds, in accordance with aspects of the present invention;

FIG. 5 is a cross-sectional view depicting exemplary modified flanges located behind a predetermined feature in a surface, the modified flanges allow improve loading and good plastic welding conditions for creating desired welds, in accordance with aspects of the present invention;

FIG. 6 is a cross-sectional view incorporating secondary flanges angled to improve loading and welding, in accordance with aspects of the present invention;

FIG. 7 is a cross-sectional view incorporating secondary flanges angled to improve loading and welding, in accordance with aspects of the present invention; and

FIG. 8 depicts a cross-sectional view of an exemplary thermoplastic welding on bulkhead ribs, in accordance with the present invention.

### DETAILED DESCRIPTION OF THE PREFERRED EMBODIMENTS

The following description of the preferred embodiment(s) is merely exemplary in nature and is in no way intended to limit the invention, its application, or uses.

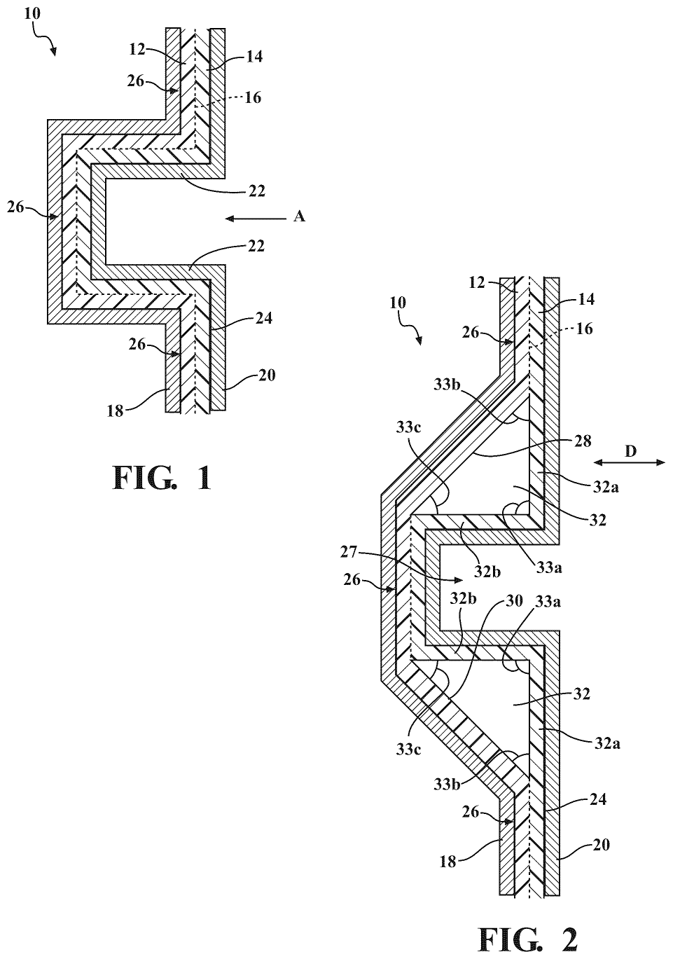

Referring to FIGS. 1-8 generally, typical flanges that do not support a good plastic welding process can be modified to create a good welding condition with special welding flanges, in accordance with aspects of the present invention.

Generally, the surface is at least 75 degrees to the welding panel load direction. The best welding situation is when the surface is 90 degrees or perpendicular to the welding panel load direction. A minimum good load angle is currently considered to be 30 degrees to panel load direction. Some surfaces and pockets, such as tail lamp pockets, bulkheads, etc., can create a poor welding condition, and can have side walls that are close to parallel to the weld load direction, or even down to 3 degrees, or 0 degrees, and this condition can be improved by adding the welding flanges.

Exemplary flanges that meet best practice weld angles and meet best practice panel loading angle are depicted. The added flanges may require special tool action such as lifters and may not be molded with just the core and cavity of the mold. The flanges are strong enough to support the pressures needed for welding, even through non-direct contact.

Referring generally to FIGS. 1-8, and more particularly to FIG. 1, there is depicted a thermoplastic welded part across flanges generally at 10, e.g., a tail lamp operably adapted for a vehicle, tailgate, liftgate, door, bulkhead, etc., including at least one first panel 12 (e.g., inner panel) and at least one second panel (e.g., outer panel) thermoplastic welded together in at least one predetermined weld location 16 (e.g., continuous weld, plurality of welds, perimeter weld, etc.). At least a first weld nest 18 and second weld nest 20 is provided. A plurality of surfaces 26 are open for loading and welding (e.g., loading the first panel 12 in the first nest 18 adjacent to the second panel 14 in the second nest 20 and thermoplastic welding 16 the parts 12,14 at predetermined locations). A load angle direction is generally depicted at arrow ‘A’ for assembly and welding. Examples of concern surfaces are shown at 22, which surfaces are not open for loading and welding, e.g., the surfaces 22 are close to parallel to the load angle ‘A’. However, a panel surface 24 is advantageously about 90 degrees to the load angle 22 (e.g., a panel surface 24 of the second panel 14 generally 90 degrees to the concern surfaces 22 generally parallel to the load angle A). According to aspects of the present invention, the load angle is about at least 30 degrees for a good quality weld and to allow for build variation and avoid wiping surfaces.

Referring generally to FIGS. 1-8, and more particularly to FIG. 2, there is depicted a thermoplastic welded part across secondary flanges 10, e.g., incorporating a tall lamp pocket, indicated generally at 27, in accordance with the present invention. A core and cavity direction is indicated at arrows ‘D.’ A plurality of predetermined secondary flanges 28,30 or bridges are provided with a predetermined open angles 33a-33c and improve loading and welding. The flanges 28 are typically at least about 10 mm wide, generally at least about 20 mm wide, preferably about 15 to 50 mm wide, more preferably about 20 to 30 mm wide, most preferably about 23 to 28 mm wide. At least one pocket 32, preferably at least one pair of pockets 32, is created from the added flanges 28, e.g., at least a first pocket leg 32a and second pocket leg 32b integrally formed with the bridge 28 provide each pocket 32. The pocket 32 is substantially triangular or other predetermined suitable shape. The pocket 32 is preferably an open area not filled with material. According to aspects of the present invention, action in the tool such as lifters or slides is required.

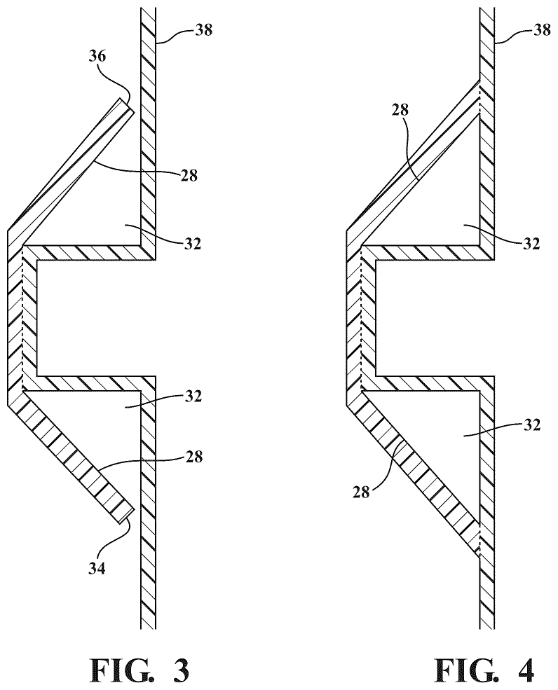

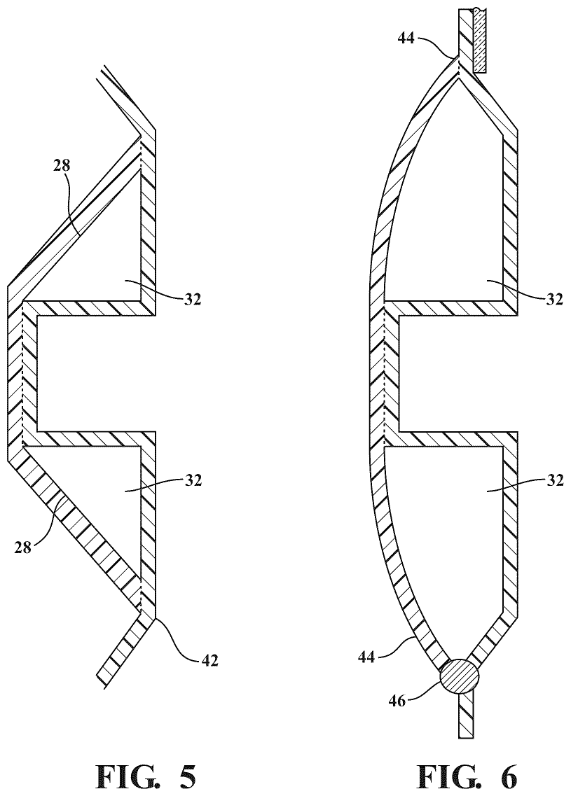

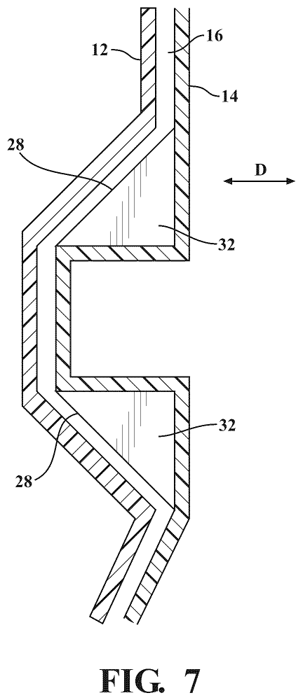

Referring generally to FIGS. 1-8, and more particularly to FIGS. 3-7, there is depicted a thermoplastic welded part across secondary flanges 10. At least one pair of pockets 32 is created from the added flanges 28. If a flange 28 is behind a visible Class “A” type surface, read through may be a concern. Therefore, there is provided exemplary methods to improve or eliminate read through. FIG. 3 depicts the flange 28 of thin material that is not fully connected, e.g., gap or opening 36 provided in the pocket 32 formed by the flange 32, e.g., to the first or second panel 38. FIG. 4 depicts the flange 28 connection, e.g., to the first or second panel 38, providing the pocket 32. FIG. 5 depicts the flanges 28 and pockets 32 located behind a feature 42 in the surface. FIG. 6 depicts moving the flanges 28 and pockets 32 to behind at least one component 44 and not behind a Class “A” surface (e.g., adjacent a trim molding 46). FIG. 7 depicts the first and second panels 12 and 14 with welding interface 16, and flanges 28,28 forming pockets 32,32.

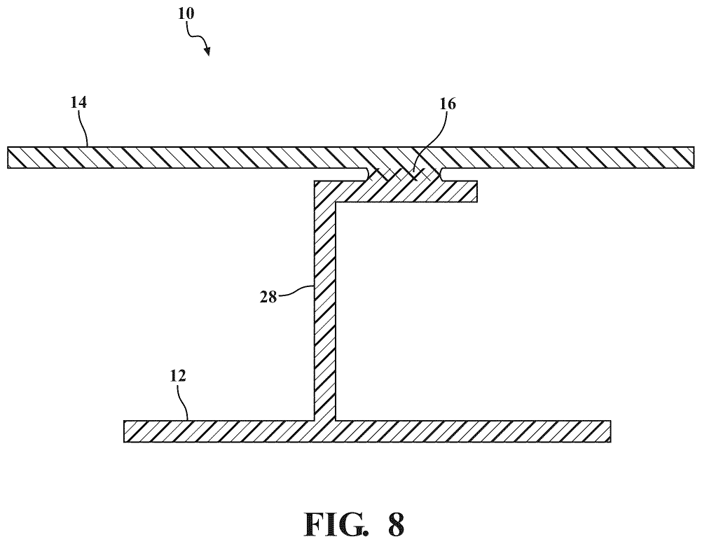

Referring generally to FIGS. 1-8, and more particularly to FIG. 8, there is depicted a thermoplastic welding on secondary flanges 10, e.g., bulkhead ribs, according to aspects of the present invention, including at least one first panel 12 (e.g., inner panel) and at least one second panel (e.g., outer panel) thermoplastic welded together in at least one predetermined weld location 16 (e.g., continuous weld, plurality of welds, perimeter weld, etc.) of the bulkhead rib 28 flange, operably adaptable with and operably incorporated with FIGS. 1-7 and as described previously.

While thermoplastic welding is described, it is understood that any alternative welding, alone or in combination, suitable for predetermined requirements such as set forth above may be used including but not limited to infrared welding, ultrasonic welding, vibration welding, gas, solvent, heat, etc.

The present invention is operably adaptable for any part shapes and surfaces relative to the load angle for assembly and welding. Flanges, ribs, or any other members.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. Method for thermoplastic welding across secondary flanges operably adapted for a component, comprising:
providing predetermined tool nesting;
providing at least one first panel and at least one second panel, said first and/or second panel incorporating at least one secondary welding flange operable to support a predetermined plastic welding operation;
plastic welding in predetermined areas where needed, or continuous weld as needed, and eliminating difficult or non-weldable areas.

2. Method of claim 1, further comprising providing tool action, wherein the tool action is at least one lifter and/or at least one slide.

3. Method of claim 1, further comprising flanges operably adapted to support predetermined pressures needed for welding, even through non-direct contact.

4. Method of claim 1, wherein the component is a tail lamp operably adapted for a vehicle.

5. Method of claim 1, further comprising providing at least a first and second tooling nest.

6. Method of claim 5, wherein the flanges are not molded with just a core and cavity of the mold.

7. Method of claim 1, wherein a surface of the panel is about 90 degrees or perpendicular to the welding panel load direction.

8. Method of claim 1, wherein a minimum good load angle is about at least 30 degrees to a panel load direction.

9. Method of claim 1, wherein no predetermined surface of the panel is substantially parallel to a panel weld load direction.

10. Method of claim 1, wherein a predetermined surface of the panel is about parallel to a weld load direction and this poor welding condition is improved by adding the welding flanges.

11. Method of claim 1, wherein a predetermined surface of the panel is about 0 to 3 degrees parallel to a weld load direction and this poor welding condition is improved by adding the welding flanges.

12. Method of claim 1, wherein said flanges eliminate non-weldable areas.

13. Method of claim 1, wherein said integrated secondary welding flanges are operably adapted to support a proper plastic welding design and operation that supports a robust design and meet best practices, and keeps cost down and complexity minimized.

14. A component operably adapted for a vehicle, comprising,
at least one first panel;
at least one second panel;
at least one pair of secondary welding members operably integrated with said first or second panel that supports a proper plastic welding design and operation that supports a robust design and meet best practices, and keeps cost down and complexity minimized.

15. claim 14, wherein said members are provided in at least one predetermined pocket area of said component.

16. claim 14, wherein said first and second panels are thermoplastic welded together.

17. claim 14, wherein the component is a tail lamp operably adapted for a vehicle, and said members eliminate non-weldable areas.

18. claim 14, wherein a minimum good load angle is about at least 30 degrees to a panel load direction.

19. claim 14, wherein said members are operably adapted to support predetermined pressures needed for welding said first and second panels together, even through non-direct contact.

20. A thermoplastic component operably adapted for a vehicle, comprising,
at least one first panel;
at least one second panel;
at least one pair of secondary welding flanges operably incorporated with said first or second panel that are angled with respect to a cavity load direction operable to improve loading of said first and second panel in weld nests and welding said first and second panels together.
